(19) United States
(12) Patent Application Publication
(10) Pub. No.: US 2003/0160845 A1
(43) Pub. Date: Aug. 28, 2003

(54) External ink supply system

(76) Inventors: Roland St. Germain, Barrington, NH (US); John Trayner, Dover, NH (US)

Correspondence Address: DEVINE, MILLIMET & BRANCH, P.A., 111 AMHERST STREET, BOX 719, MANCHESTER, NH, 03105, US

(21) Appl. No.: 10/080,833

(22) Filed: Feb. 22, 2002

(51) Int. Cl. B41J 2/175

(52) U.S. Cl. 347/85

(57) ABSTRACT

The present invention is an ink disbursement apparatus. The apparatus includes a cartridge, which is mateable to an ink jet printer. The cartridge includes a pierceable membrane on at least a portion of a side of the cartridge. The apparatus further includes a tube with at least two openings and formed therein, wherein a first opening formed in the tube is connected to the cartridge at the pierceable membrane whereby the membrane covers the first opening until the membrane is pierced. The apparatus further includes one airtight bladder filled with ink external to the cartridge. Finally, the apparatus includes a bladder opening formed in the bladder mated to a second opening formed in the tube thereby permitting the ink to be transported from the bladder, through the tube, to the first opening formed in the tube.

### FIELD

The present invention is in the field of industrial ink jet printers. More specifically, the present invention is in the field of external ink supplies for ink jet printers.

### BACKGROUND OF THE INVENTION

Presently, there is a large demand for industrial ink jet printers. Industrial ink jet printers are used by professional printers for manufacturing posters, large pictures and similar printed material that the average consumer cannot print from a home computer. These industrial printers, when used efficiently, consume a tremendous amount of ink. As a result there is a tremendous demand for ink cartridges or other ink supplies.

Standard ink cartridges have a number of limitations. One of the limitations is the amount of ink available in any single cartridge. Most cartridges will hold six ounces of ink, which, while capable of completing many projects, still must be replaced often in regularly used industrial ink jet printers. As a result, it would be helpful to have ink cartridges capable of storing more than six ounces of ink.

Ink cartridges are also somewhat proprietary, in that each manufacturer of ink jet printers may choose to make ink cartridges in a non-uniform manner. Therefore, ideally anyone attempting to manufacture ink cartridge with additional ink must design a system that can be used for a multitude of differing cartridge styles.

One system has been designed for external ink supplies. The ink supply is stored in an open bottle and connected to an ink cartridge. However, the problem with using the bottle is there is no means for keeping air out of the bottle and away from the ink. Exposure to air can cause the ink to dry and otherwise clog in the system. Therefore, an ideal external ink supply would be air-free.

### SUMMARY OF THE INVENTION

The present invention is realized as a result of connecting an airtight, hermetically sealed bladder filled with ink through a hollowed ink cartridge to an ink jet printer, thereby supplying the printer with more ink than could be provided in a standard cartridge adaptably to many different printers without exposing the contained ink to air.

Therefore, it is an object of the present invention to provide an external ink supply that carries more ink than an average ink cartridge.

It is a further object of the present invention to provide an external ink supply system that is easily adaptable to a multitude of different printers.

It is a further object of the present invention to provide an external ink supply that does not expose the ink to air prior to use through the printer.

### BRIEF DESCRIPTION OF THE DRAWINGS

FIG. 1 shows one embodiment of the external ink supply apparatus

FIG. 2 shows a cross-section of the ink supply in one embodiment.

FIG. 3 shows a cross-section of the cartridge member in one embodiment.

FIG. 4 shows a flow chart of one embodiment of the method of making the ink disbursement apparatus.

FIG. 5 shows a flow chart of one embodiment of the method of making the ink disbursement apparatus.

FIG. 6 shows one embodiment of the external ink supply system.

FIG. 7 shows a cross-section of one embodiment of the external ink supply system.

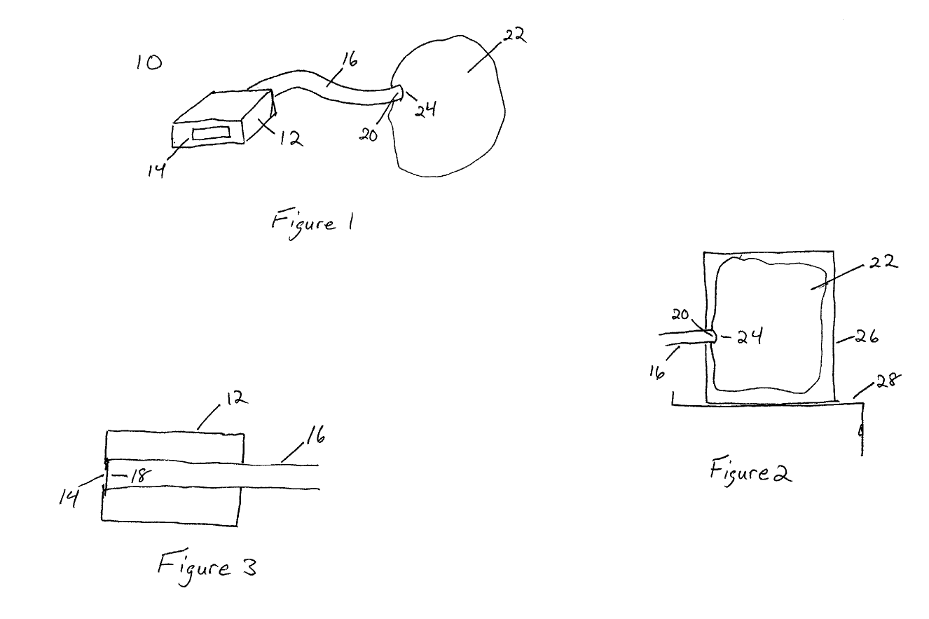

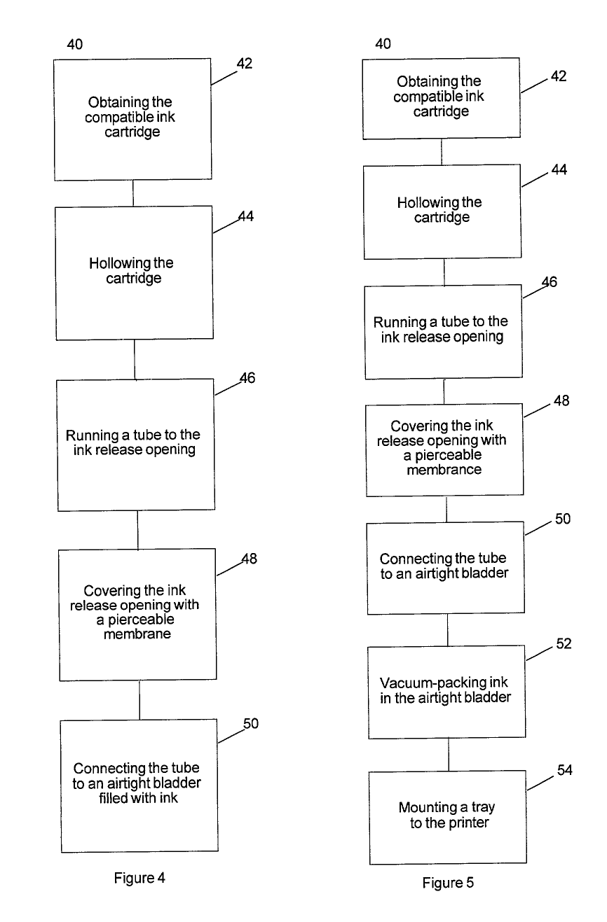

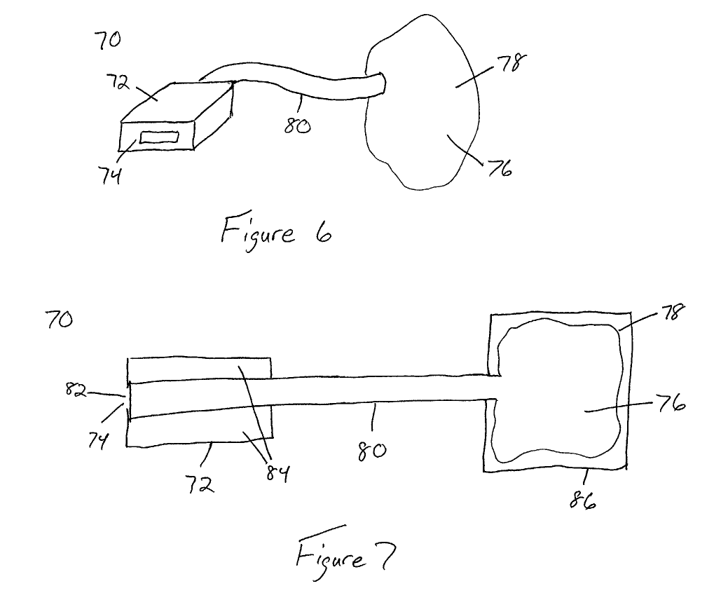

### DETAILED DESCRIPTION OF THE INVENTION

The present invention is an ink disbursement apparatus 10. The apparatus 10 includes a cartridge 12, which is mateable to an ink jet printer. Generally, ink jet printers each have their own proprietary style ink jet cartridges 12 for supplying ink. Therefore the present invention by design can be used with any style ink jet cartridge 12 thereby making it applicable to any style ink jet printer. The cartridge 12 includes a pierceable membrane 14 on at least a portion of a side of the cartridge 12. The apparatus 10 further includes a tube 16 with at least two openings 18 and 20 formed therein, wherein a first opening 18 formed in the tube 16 is connected to the cartridge 12 at the pierceable membrane 14 whereby the membrane 14 covers the first opening 18 until the membrane 14 is pierced. The apparatus further includes one airtight bladder 22 filled with ink external to the cartridge 12. Finally, the apparatus includes a bladder opening 24 formed in the bladder 22 mated to a second opening 20 formed in the tube 16 thereby permitting the ink to be transported from the bladder 22, through the tube 16, to the first opening 18 formed in the tube 16.

When the ink disbursement apparatus 10 is used, the cartridge 12 is plugged into the ink jet printer at a mating point. The printer pierces the pierceable membrane 14 at the mating point thereby releasing ink to the printer. At no point in the application of this system does the ink need to be exposed to air until its use by the printer.

A narrower embodiment of this invention uses a rigid container 26, preferably a box, to store the bladder 22. Another narrower embodiment of this invention involves having the pierceable membrane 14, the tube 16, and the bladder 22 combine to form a gas impermeable, vacuum-packed, hermetically sealed container. Another narrower embodiment of the present invention further includes a tray 28 mountable to the printer wherein the tray 28 supports the bladder 22. A final narrower embodiment of the present invention occurs wherein the bladder 22 is supported at a height between twelve inches above and six inches below the cartridge 12 thereby providing for optimal ink flow. It has been determined through research that locating the bladder at height greater than this range results in FILL IN THE BLANK and locating the bladder at a height lower than this range results in FILL IN THE BLANK.

The present invention is also a method 40 for making an ink disbursement apparatus 10 for a specific ink jet printer mateable with a compatible ink cartridge 12. The first step of the inventive method 40 involves obtaining 42 the compatible ink cartridge 12 having an ink release opening and a back. The next step to the method 40 is hollowing 44 the cartridge 12 and forming a back opening in the back. The next step is running 46 a tube 16 though the back opening and connecting it to the ink release opening. The next step is covering 48 the ink release opening with a pierceable membrane 14. The final step to the inventive method 40 is connecting 50 the tube 16 to an airtight bladder 22 filled with ink.

A narrower embodiment of the inventive method 40 involves vacuum-packing 52 the ink in the airtight bladder 22.

Another narrower embodiment of the inventive method 40 involves mounting 54 a tray 28 to the printer at a predetermined height relative to a mating point between the printer and the ink cartridge 12 thereby providing a location for the bladder 22 to be stored. A narrower embodiment of this embodiment involves the predetermined height being between twelve inches above and six inches below the mating point thereby providing for optimal ink flow.

The present invention may also be described as an external ink supply system 70. The inventive system 70 includes an ink cartridge 72 with a pierceable membrane 74. The system 70 further includes an ink supply 76 substantially stored in a pliable container 78 exterior to the ink cartridge 72. Finally, the external ink supply system 70 includes a fluid conduit 80 connecting the ink cartridge 72 to the ink supply 76 stored in the pliable container 78 wherein the ink supply 76 is vacuum-packed and hermetically sealed within the cartridge 72, container 78 and conduit 80.

A further embodiment of the present ink supply system 70 requires the membrane 74 sealing an opening 82 in the cartridge 72 and the fluid conduit 80 envelops the opening 82 whereby ink passes through the cartridge 72, but does not contact an interior 84 of the cartridge 72. Another narrow embodiment of the present inventive system 70 requires having the container 78 stored in a substantially rigid container 86.

What we claim is:

1. An ink disbursement apparatus comprising:
a cartridge;
a pierceable membrane on at least a portion of a side of the cartridge;
a tube with at least two openings formed therein, wherein a first opening formed in the tube is connected to the cartridge at the pierceable membrane whereby the membrane covers the first opening until the membrane is pierced;
one airtight bladder filled with ink external to the cartridge; and
a bladder opening formed in the bladder mated to a second opening formed in the tube thereby permitting the ink to be transported from the bladder, through the tube, to the first opening formed in the tube.

2. The ink disbursement apparatus of claim 1 further comprising a rigid container in which the bladder is stored.

3. The ink disbursement apparatus of claim 1 wherein the pierceable membrane, the tube, and the bladder combine to form a gas impermeable, vacuum-packed, hermetically sealed container.

4. The ink disbursement apparatus of claim 1 further comprises a tray mountable to the printer wherein the tray supports the bladder.

5. The ink disbursement apparatus of claim 1 wherein the bladder is supported at a height between twelve inches above and six inches below the cartridge thereby providing for optimal ink flow.

6. A method for making an external ink supply apparatus for a specific ink jet printer mateable with a compatible ink cartridge, said method comprising the steps of:
obtaining the compatible ink cartridge having an ink release opening and a back;
hollowing the cartridge and forming a back opening in the back;
running a tube though the back opening and connecting it to the ink release opening;
covering the ink release opening with a pierceable membrane; and
connecting the tube to an airtight bladder filled with ink.

7. The method of claim 6 further comprising vacuum-packing the ink in the airtight bladder.

8. The method of claim 6 further comprising:
mounting a tray to the printer at a predetermined height relative to a mating point between the printer and the ink cartridge thereby providing a location for the bladder to be stored.

9. The method of claim 8 wherein the predetermined height is between twelve inches above and six inches below the mating point.

10. An external ink supply system comprising:
an ink cartridge with a pierceable membrane;
an ink supply substantially stored in a pliable container exterior to the ink cartridge; and
a fluid conduit connecting the ink cartridge to the ink supply stored in the pliable container wherein ink supply is vacuum-packed and hermetically sealed within the cartridge, container and conduit.

11. The ink supply system of claim 10 wherein the membrane seals an opening in the cartridge and the fluid conduit envelops the opening whereby ink passes through the cartridge, but does not contact an interior of the cartridge.

12. The ink supply system of claim 10 wherein the container is stored in a substantially rigid container.
